(19) United States
(12) Patent Application Publication
(10) Pub. No.: US 2015/0252780 A1
(43) Pub. Date: Sep. 10, 2015

(54) WIND TURBINE BLADE SPAR WEB HAVING ENHANCED BUCKLING STRENGTH

(71) Applicant: Siemens Aktiengesellschaft, München (DE)

(72) Inventor: Yellavenkatasunil Jonnalagadda, Westminster, CO (US)

(73) Assignee: Siemens Aktiengesellschaft, München (DE)

(21) Appl. No.: 14/200,109

(22) Filed: Mar. 7, 2014

(51) Int. Cl. F03D 1/06

(52) U.S. Cl. CPC F03D 1/0675

(57) ABSTRACT

A wind turbine blade (10), including a pressure side (12); a suction side (14), and a shear web (82) secured to the pressure side and to the suction side The shear web includes. a pressure side arrangement (84) secured to the pressure side and which narrows toward the suction side; and a suction side arrangement (86) secured to the suction side and which narrows toward the pressure side.

### FIELD OF THE INVENTION

The invention relates to a wind turbine blade shear web having increased buckling strength.

### BACKGROUND OF THE INVENTION

Wind turbine blades used in conventional wind turbines commonly include a pressure side, a suction side, and a shear web internal to the blade and connecting the pressure side to the suction side The shear web typically functions to transfer shear loads between the pressure side and the suction side that result from flap-wise deformation of the blade during operation Flap-wise deformation results in a tendency for a cross-sectional shape of the blade to flatten, a phenomenon known as the Brazier Effect In conventional blades this flattening is mostly seen near the max-chord region where the cross sectional dimension is much larger than the shell thickness, and hence the shear web in this max-chord region had a larger “column length”. The longer column length leaves the shear web more vulnerable to crushing loads that are in excess of the capacity of a shear web designed primarily to transfer shear loads

To accommodate the locally increased vulnerability, one approach has simply been to increase the thickness of the shear web in the max-chord region. However, this increases the mass of the rotating blade and that increases centrifugal loads and reduces engine efficiency Another approach has been to remove a portion of the shear web in this local region This approach permits the blade to flatten in this region but retains enough of the shear web to permit sufficient distribution of shear loads through the shear web

### BRIEF DESCRIPTION OF THE DRAWINGS

The invention is explained in the following description in view of the drawings that show.

FIG. 1 shows flap deflection of a wind turbine blade.

FIG. 2 shows flattening of the wind turbine blade of FIG. 1 at the max-chord region

FIG. 3 shows a wind turbine blade with a prior art shear web design

FIG. 4 shows a prior art shear web with a cut-out to accommodate flattening

FIG. 5 is a cross sectional view of an exemplary embodiment of a shear web design disclosed herein and installed in a blade

FIG. 6 shows the exemplary embodiment of a shear web using the shear web design of FIG. 5

FIG. 7 shows an exemplary embodiment of a shear web where the shear web design of FIG. 5 is incorporated locally into the shear web

FIG. 8 is a cross sectional view of an alternate exemplary embodiment of the shear web design disclosed herein and installed in a blade.

FIGS. 9-16 depict an exemplary embodiment of a method of manufacturing a wind turbine blade incorporating the shear web design disclosed herein.

### DETAILED DESCRIPTION OF THE INVENTION

The present inventor has recognized negative effects in existing wind turbine blades that result from flattening of the blade that occurs due to flap-wise deflection, and has identified other related problems that are likely to develop as blades continue to increase in length. In response, the inventor has developed an innovative shear web design that provides increased buckling strength The shear web design improves on the prior art in that it resists buckling more effectively, permits the required distribution of shear load, but adds little additional weight, thereby maintaining overall efficiency. The resulting increased buckling strength provides a stiffer blade, and this reduces other problems, such as an increase in hoop stress at the trailing edge that is induced when the blade flattens

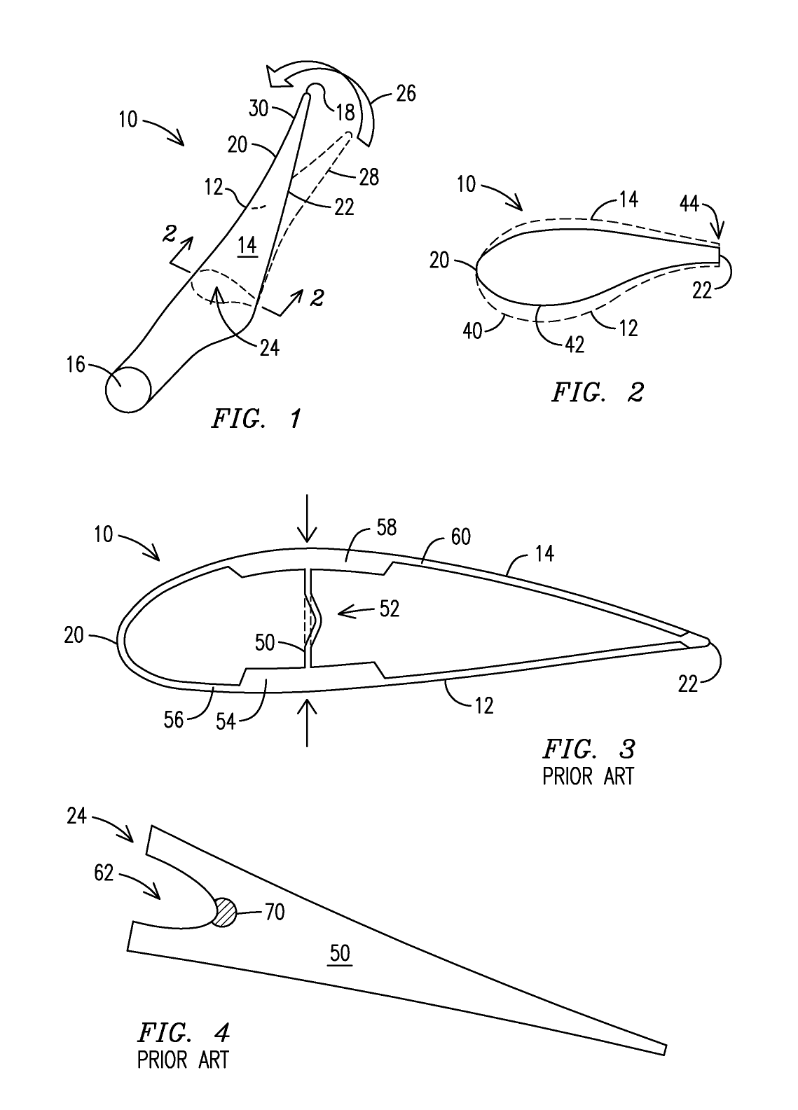

Buckling is a critical failure mode and its design criteria play a key role in designing wind turbine blades. There are various types of buckling failure modes often seen in a wind turbine blade such as shell buckling, trailing edge buckling, and web buckling etc. Web buckling can occur when a wind turbine blade experiences crushing loads that occur due to “flattening” or “ovalization” of a cross section of the wind turbine blade during flap-wise deflection FIG. 1 shows a wind turbine blade 10 with a pressure side 12, a suction side 14, a base 16, a tip 18, a leading edge 20, a trailing edge 22, and a max-chord region 24 where a chord of the blade 10 is longest Arrow 26 shows flap-wise deflection that may occur as a result of, for example, forces generated by environmental wind, from a neutral position 28 to a deflected position 30 As can be seen in FIG. 2, a neutral perimeter 40 of the blade 10 exists when the blade 10 is in the neutral position 28, while a flattened perimeter 42 occurs when the blade 10 is in the deflected position 30 Arrow 44 shows a region toward the trailing edge 22 that experiences increased hoop stress as a result of flattening As blades grow in length hoop stresses in this region would begin to become more of a factor in blade design if the flattening were not addressed.

FIG. 3 discloses a prior art shear web 50 that secures to the pressure side 12 and the suction side 14 The prior art shear web 50 is part of a spar 52 that also includes a pressure side spar cap 54 integrated into a pressure side skin 56, a suction side spar cap 58 integrated into the suction side skin 60, and fiber reinforcement (not distinguished) that spans from the pressure side 12 to the suction side 14. When in the neutral position 28 the prior art shear web 50 assumes a web-neutral shape as indicated by the dotted lines During flap-wise deflection the flattening induces a crushing load on the prior art shear web 50 that, if sufficient, can induce buckling in the prior art shear web 50 as indicated by the solid line Buckling is a function of a column height of a component, which considers a height of the component and its width In the max-chord region 24 the column height is greatest, and hence the risk of buckling is the greatest in this region. Consequently, the improved web design disclosed herein may be located throughout an entire length of the blade 10, or it may be incorporated only locally in the max-chord region 24

FIG. 4 discloses a prior art solution to buckling that includes removing a portion of the prior art shear web 50 to form a void 62 in the max-chord region 24 The void 62 permits buckling to occur unimpeded but leaves enough web material to sufficiently transfer shear loads However, as the blade lengths increase the local region subject to buckling also increases as do the shear loads that need to be handled by the prior art shear web 50 This design that results after balancing these (and other) factors may be limited by buckling loads in a buckle region 70 adjacent the void 62. This is likely to get worse as blade lengths increase

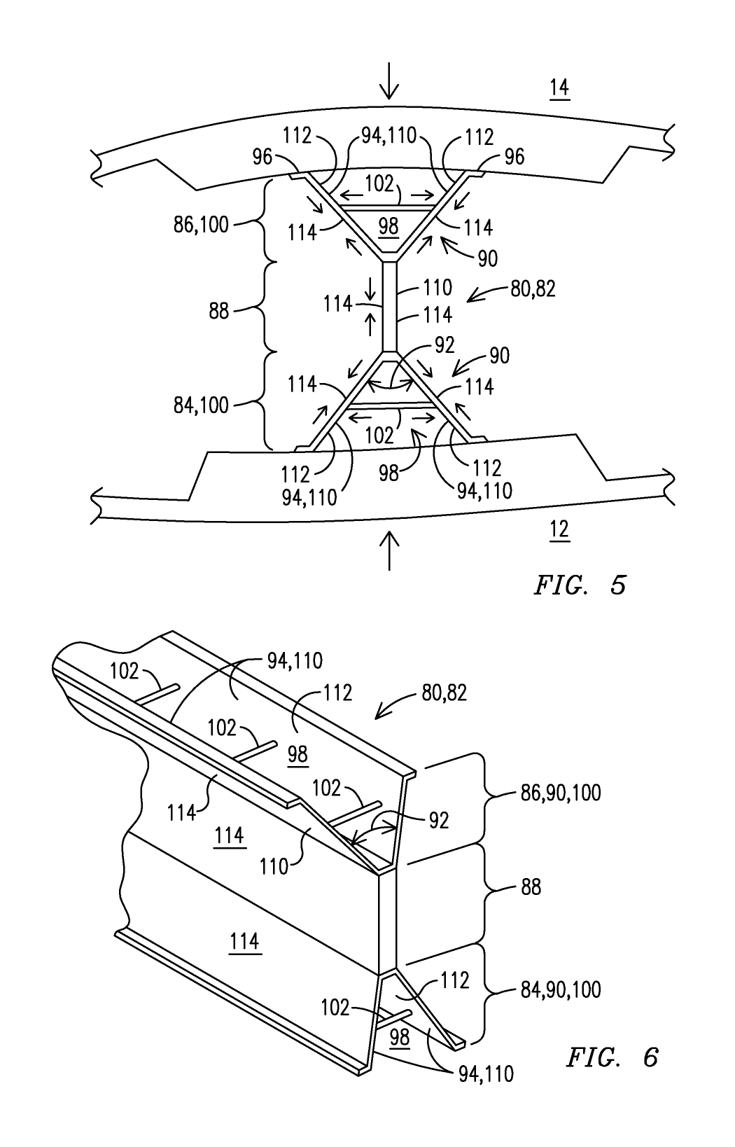

To address this, a new shear web design 80 has been devised and is incorporated into a shear web 82 as shown in FIG. 5 to form some or all of the shear web 82. The shear web 82 includes a pressure side arrangement 84, a suction side arrangement 86, and a flattened web section 88. The pressure side arrangement 84 and/or the suction side arrangement 86 may be an angled flange 90 that forms an angle 92 between opposing walls 94 that may secure to the respective side at attachments 96. The opposing walls 94 may be radially oriented with respect to the blade 10. The angle 92 may be such that the opposing walls 94 may converge on each other (narrow) with distance from the attachments 96. The opposing walls 94 may form a radially oriented chamber 98 within the shear web 82, and hence the radially oriented chambers 98 may be seen as bifurcating ends 100 of the shear web 82. One or more tensile stiffeners 102 may be disposed between the opposing walls 94 on either or both of the pressure side arrangement 84 and the suction side arrangement 86 and the number/population density of tensile stiffeners 102 may vary locally throughout the shear web 82. The flattened web section 88 is optional and may resemble a conventional shear web that connects the pressure side arrangement 84 and the suction side arrangement 86.

During flap-wise deflection, the crushing load exerts a compressive force on the shear web 82 and its individual components as indicated by the arrows next to the opposing walls 94 Unlike the prior art shear web 50 that had only a single component, and hence a single load path between the pressure side 12 and the suction side 14, the pressure side arrangement 84 and the suction side arrangement 86 each present two load paths 110 Similar to the prior art shear web 50 the flattened web section presents a single load path 110. In addition to providing additional load paths 110, the new shear web design 80 shortens the column height of each component that provides a load path 110, such as the opposing walls 94 and the flattened web section 88. Since buckling strength increases as the column height decreases, each component has greater buckling strength than the longer prior art component, so the shear web 82 has increased buckling strength overall Further, under a compressive load the pressure side 12 and the suction side 14 tend to flatten This urges the attachments 96 apart which increases the angle 92 The tensile stiffener 102 disposed between the opposing walls 94 resists this spreading and hence acts to convert compressive load into tensile load as indicated by the arrows adjacent the tensile stiffener 102. Thus, the new shear web design provides additional load paths 110, shortens the column height of each load path 110, and converts some of the compressive load into tensile load. Together these actions provide a shear web 82 having improved buckling strength

The flattened web section 110 may include core material under reinforcing fiber as is known conventionally, or may include only core material Since the strength requirements are reduced in the flattened web section 110, it may be made lighter. The same principles apply to the arrangements In particular, since the tensile stiffeners 102 bear a tensile load, they may be relatively thinner and even more lightweight The opposing walls may or may not have reinforcing fiber on internal surface 112 and the shear web 82 may have reinforcing fiber on external surfaces 114 that extends from the pressure side 12 to the suction side 14. FIG. 6 is a perspective view of the shear web of FIG. 5 by itself

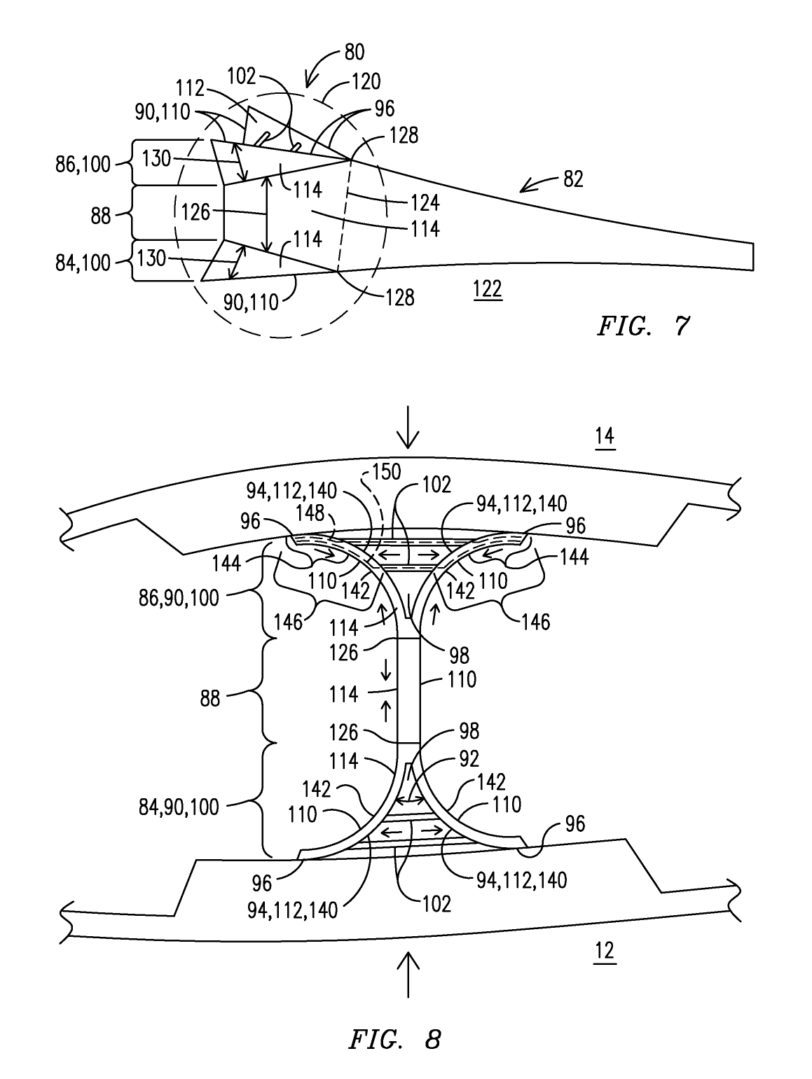

FIG. 7 shows an exemplary embodiment of a shear web 82 incorporating the new shear web design 80 in a local portion 120 of the shear web 82. The local portion 120 may coincide with the max-chord region 24 of the blade 10 or any region that may benefit from an increased buckling strength. In a remaining region 122 a conventional shear web design may be present A transition 124 marks where the conventional web design meets the new shear web design 80 In the exemplary embodiment shown, attachments 96 of the opposing walls 94 and a joint 126 between the opposing walls 94 and the flattened web section 88 may merge with the conventional shear web design to form convergence points 128. A taper 130 in the opposing walls 94 allows for a gradual change in the amount of buckling strength and a corresponding gradual change in the mass of the blade 10 within the local portion 120. The number, population density, attachment means, and size etc of the tensile stiffeners can vary as necessary to accommodate the needs within the local portion 120. The taper 130 may continue until the pressure side arrangement 84 meets the suction side arrangement 86. Alternately, the taper 130 may stop before the joints 126 meet, and in such an exemplary embodiment, the flattened web section 88 would exist between the pressure side arrangement 84 meets the suction side arrangement 86 The local portion 120 is secured to a remaining region 122 of the blade 10 closer to the tip 18. While not visible, the same principles above apply to the local portion 120 where secured to a remaining region 122 of the blade 10 closer to the base 16. Alternately, the local portion 120 visible in this figure may extend all of the way to the base 16 of the blade 10

FIG. 8 shows an alternate exemplary embodiment of the new web design 80 where the opposing walls 94 of the flange 90 are curved and form a convex side 140 and a concave side 142 In the exemplary embodiment shown the tensile stiffeners 102 are secured to the convex sides 142 of the curved opposing walls 94 as shown In this configuration, when the crushing load acts to flatten the pressure side 12 and the suction side 14 and spread the attachments 96 apart, the curved opposing walls 94 tend to bend more, thereby increasing their curvature As a result of this increase in curvature, a portion 144, 146 of each wall between the attachment 96 and a respective tensile stiffener 102 more closely aligns with the orientation of the respective tensile stiffener 102. This creates a straighter load path 148, 150 during a crushing load starting from one attachment 96, going through the more-aligned portion 144, 146 of one opposing wall 94, through the respective tensile stiffener(s) 102, through the more-aligned portion 144, 146 of the other opposing wall 94, to the other attachment 96. Forming a straighter tensile load path 144, 146 in response to the crushing load helps the curved opposing walls 94 better resist bending loads due to the alignment of the load path 148, 150 with the orientation of the opposing walls 94 and respective tensile stiffener 102 This permits the use of lighter materials. Hence the layup for these curved opposing walls 94 may or may not include sandwich core which can be effective in resisting bending loads. As shown, several tensile stiffeners 102 may be positioned at various positions along a length of the opposing walls 94 The tensile stiffeners 102 may be oriented parallel to the nearest side or may take other orientations as various design criteria deem desirable.

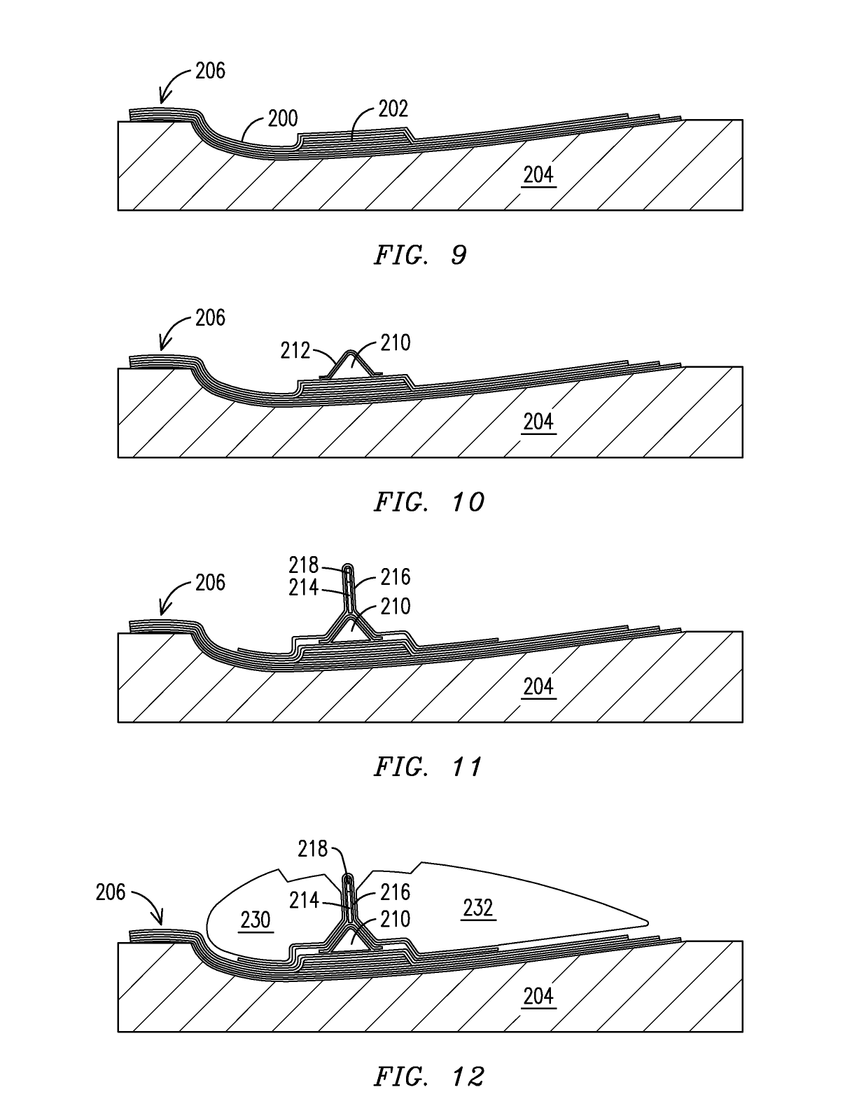

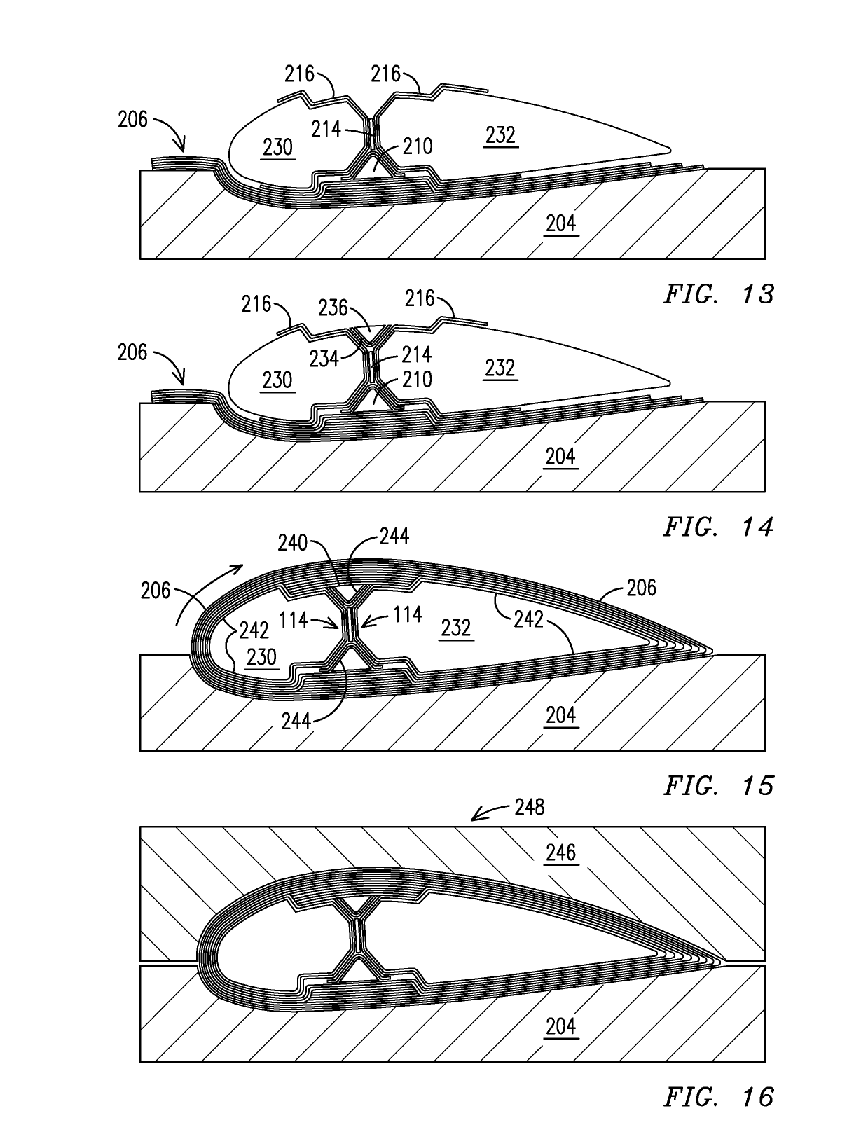

FIGS. 9-16 depict an exemplary embodiment of a method of manufacturing a blade 10 that incorporates the shear web 82 having the new shear web design 80

Shell layers 200 and beam layers 202 (a.k a. spar cap layers 202) are placed on a lower mold 204. A layer may include one or several layers of reinforcing fiber and/or a matrix material. A portion 206 of the shell layers 200 to be used later are draped over the mold temporarily. A lower secondary mandrel 210 is placed on the beam layers 202 and a cover layer 212 is placed over the lower secondary mandrel 210 The lower secondary mandrel 210 forms the bifurcated end 100 which form the radially oriented chamber 98. A core 214 made of, for example, plywood, is positioned over the lower secondary mandrel 210 and web layers 216 are positioned over the core 214 The core 214 forms the flattened web section 88. A removable extension 218 may be placed on the core 214 and the web layers 216 extend over the removable extension 218. Primary mandrels 230, 232 are positioned on the shell layers 200 and the web layers 216 that had been extended over the removable extensions 218 are split and spread on the primary mandrels 230, 232 The removable extension 218 is removed, an upper cover layer 234 is spread on the primary mandrels 230, 232, and an upper secondary mandrel 236 is positioned on the upper cover layer 234. The upper secondary mandrel 236 forms the bifurcated end 100 which form the radially oriented chamber 98. Upper beam layers 240 are positioned on the primary mandrels 230, 232 and the upper secondary mandrel 236, and the portion 206 of the shell layers 200 that were previously draped over the lower mold 204 are wrapped over the primary mandrels 230, 232 and the beam layers 240 to complete the outer skin of the blade 10. Thus, the primary mandrels 230, 232 define an internal surface 242 of the pressure side and the suction side and the external surface 114 of the shear web 82, while the secondary mandrels define internal surfaces 244 of the shear web 82. An upper mold 246 is positioned over the lower mold 204, thereby closing a mold assembly 248. Resin is injected and cured after which the molds and mandrels are removed. Any or all of the mandrels may be inflatable, and hence deflated to facilitate removal Once the mandrels are removed the tensile stiffeners may be installed manually using fastening techniques known to those in the art. For example, holes may be drilled, tensile stiffeners installed in the holes, and bolts may be used to secure to tensile stiffeners in place Various other finalizing steps may then be taken to produce a completed blade 10

From the foregoing it can be seen that the inventor has created a unique shear web design configured to reduce column lengths of individual components, create plural load paths where previously there was only one, and to convert compressive load to tensile load These factors work together to increase the buckling strength of the shear web without greatly increasing the mass of the shear web. This provides a more rigid blade that retains overall efficiency of the wind turbine, while reducing concerns that come with ever-increasing blade lengths, such as hoop stresses at the trailing edge associated with the flattening that occurs without the new shear web design Therefore, the new web design disclosed herein represents an improvement in the art.

While various embodiments of the present invention have been shown and described herein, it will be obvious that such embodiments are provided by way of example only Numerous variations, changes and substitutions may be made without departing from the invention herein. Accordingly, it is intended that the invention be limited only by the spirit and scope of the appended claims

The invention claimed is:

1. A wind turbine blade, comprising
a pressure side, a suction side, and a shear web secured to the pressure side and to the suction side;
wherein the shear web comprises a pressure side arrangement secured to the pressure side and which narrows toward the suction side, and a suction side arrangement secured to the suction side and which narrows toward the pressure side

2. The wind turbine blade of claim 1, wherein the shear web further comprises a flattened web section disposed between the pressure side arrangement and the suction side arrangement.

3. The wind turbine blade of claim 1, wherein at least one of the pressure side arrangement and the suction side arrangement comprises two opposing walls that converge on each other toward the opposite side of the wind turbine blade

4. The wind turbine blade of claim 3, wherein each of the two opposing walls is curved and a convex side of each wall faces the other opposing wall.

5. The wind turbine blade of claim 3, wherein the pressure side arrangement comprises two opposing walls that converge on each other toward the suction side, and wherein the suction side arrangement comprises two opposing walls that converge on each other toward the pressure side.

6. The wind turbine blade of claim 3 wherein the shear web further comprises a tensile stiffener securing the two opposing walls to each other.

7. The wind turbine blade of claim 1, wherein the shear web is disposed at a max-chord region of the wind turbine blade.

8. A wind turbine blade, comprising.
a pressure side and a suction side;
a shear web comprising. a pressure side arrangement configured to secure the shear web to the pressure side, and a suction side arrangement configured to secure the shear web to the suction side;
wherein at least one of the pressure side arrangement and the suction side arrangement comprises opposing walls, each wall configured to provide a load path between the pressure side and the suction side of the wind turbine blade

9. The wind turbine blade of claim 8, wherein each load path is secured to a respective side at respective attachment, and wherein a distance between the two load paths decreases with increasing distance from the respective attachments

10. The wind turbine blade of claim 8, wherein the shear web further comprises a flattened web section configured to provide a single load path between the pressure side and the suction side

11. The wind turbine blade of claim 10, wherein the pressure side arrangement comprises opposing walls, each wall configured to provide a load path between the pressure side and the flattened web section, and wherein the suction side arrangement comprises opposing walls, each configured to provide a load path between the suction side and the flattened web section

12. The wind turbine blade of claim 8, wherein the shear web further comprises a tensile stiffener disposed between the opposing walls

13. The wind turbine blade of claim 12, wherein each wall is curved and the tensile stiffener is secured between the opposing walls and to a convex side of each wall.

14. A wind turbine blade comprising;
a pressure side, a suction side, and a shear web secured there between, wherein the shear web further comprises.
an end arrangement comprising opposed and spaced apart walls terminating at respective spaced apart attachments to a respective one of the pressure or suction sides, the walls configured to provide one load path each between the pressure and suction sides for resisting flattening of the wind turbine blade.

15. The wind turbine blade of claim 14, wherein the walls taper together with distance from the respective attachments

16. The wind turbine blade of claim 14, wherein each wall is curved, each wall comprises a convex side, and the convex sides face each other

17. The wind turbine blade of claim 14, the end arrangement further comprising a tensile stiffener disposed between the walls

18. The wind turbine blade of claim 15, the shear web further comprising a flattened web section disposed between the end arrangement and a side of the wind turbine blade opposite the respective attachments, the flattened web section configured to provide only one load path.

19. The wind turbine blade of claim 18,
wherein the end arrangement is secured to the pressure side of the wind turbine blade,
wherein the wind turbine blade further comprises an additional end arrangement comprising opposed and spaced apart walls terminating at respective spaced apart attachments to the suction side, the walls configured to taper toward each other with distance from the respective attachments and to provide one load path each between the pressure and suction sides for resisting flattening of the wind turbine blade,
wherein the flattened web section is disposed between the end arrangements, and
wherein the one load path of the flattened web section provides all buckling strength between the end arrangements

20. The wind turbine blade of claim 19, wherein each end arrangement comprises a plurality of tensile stiffeners, each tensile stiffener being disposed between and secured to respective walls, and each configured to prevent separation of respective attachments
